(19) United States
(12) Patent Application Publication
(10) Pub. No.: US 2024/0210682 A1
(43) Pub. Date: Jun. 27, 2024

(54) OPTICAL SYSTEM FOR HEAD-UP DISPLAY SYSTEM

(71) Applicant: LETINAR CO., LTD, Anyang-si (KR)

(72) Inventors: Jeong Hun HA, Seoul (KR); Kyu Ho KIM, Seongnam-si (KR)

(73) Assignee: LETINAR CO., LTD, Anyang-si (KR)

(21) Appl. No.: 18/468,382

(22) Filed: Sep. 15, 2023

(30) Foreign Application Priority Data
Dec. 21, 2022 (KR) 10-2022-0180719
Mar. 17, 2023 (KR) 10-2023-0035357

(51) Int. Cl. G02B 27/01

(52) U.S. Cl. CPC G02B 27/0101; G02B 2027/011

(57) ABSTRACT

Disclosed herein is an optical system for a head-up display (HUD) system. The optical system includes: an image output unit configured to output virtual image light; and a plurality of optical elements configured to transfer the virtual image light to a windshield; wherein the plurality of optical elements are each disposed at an inclination angle with respect to the image output unit and the windshield so that the virtual image light is transferred to an eyebox through the windshield; and at least some of the plurality of optical elements are arranged along a first straight line with the centers thereof having a distance within a preset range from the first straight line, and at least another some of the plurality of optical elements are disposed along a second straight line with the centers thereof having a distance within a preset range from the second straight line.

### CROSS-REFERENCE TO RELATED APPLICATION

This application claims the benefit of Korean Patent Applications No. 10-2022-0180719 filed on Dec. 21, 2022 and No. 10-2023-0035357 filed on Mar. 17, 2023, which are hereby incorporated by reference herein in its entirety.

### BACKGROUND

### 1. Technical Field

The present invention relates to an optical system for a head-up display (HUD) system, and more particularly, to an optical system for a HUD system capable of significantly reducing the volume thereof while enlarging an eyebox and a field of view.

### 2. Description of the Related Art

In general, a HUD system refers to a system that provides various types of information to a driver or pilot by projecting virtual images onto a combiner in front of the driver or pilot in a vehicle or airplane.

A HUD system generally includes a combiner and an optical system. The optical system includes a display unit for displaying each virtual image and outputting virtual image light corresponding to the virtual image, a collimator for converting the virtual image light, output from the display unit, into parallel light and outputting it, and an optical element, such as a reflective unit, for transferring the virtual image light, output from the collimator, to a combiner.

Furthermore, windshields placed in the front of vehicles are frequently used as such combiners.

In such a HUD system, it is important to enlarge an eyebox and a field of view. However, in order to enlarge them, there is a problem in that the volume of an optical system including a display unit, a collimator, and an optical element also increases.

### SUMMARY

The present invention has been conceived to overcome the above-described problems, and an object of the present invention is to provide an optical system for a HUD system capable of significantly reducing the volume thereof while enlarging an eyebox and a field of view.

According to an aspect of the present invention, there is provided an optical system for a head-up display (HUD) system, the optical system including: an image output unit configured to output virtual image light; and a plurality of optical elements configured to transfer the virtual image light to a windshield; wherein the plurality of optical elements are each disposed at an inclination angle with respect to the image output unit and the windshield so that the virtual image light is transferred to an eyebox through the windshield; and at least some of the plurality of optical elements are arranged along a first straight line with the centers thereof having a distance within a preset range from the first straight line, and at least another some of the plurality of optical elements are disposed along a second straight line with the centers thereof having a distance within a preset range from the second straight line.

When the lateral- and vertical-axis directions of the image output unit are called x_{d} and y_{d} axes, respectively, and a normal line from a center of a surface of the image output unit is called a z_{d} axis, the first and second straight lines may be straight lines that are included in a y_{d}z_{d} plane defined by the y_{d} and z_{d} axes.

When lateral and vertical directions of the eyebox are called an x axis and a y axis, respectively, and a normal direction from a center of a surface of the eyebox is called a z axis, and when straight lines corresponding to a field of view θe in a y-axis direction required by the eyebox are called Le2 and Le3, respectively, and straight lines corresponding to a maximum divergence angle θc in a y_{d}-axis direction of the image output unit are called Lc2 and Lc3, respectively: the first straight line may be a straight line obtained by symmetrically moving a straight line between an intersection point B, where the straight lines Le3 and Lc3 meet each other, and a center C around the windshield; the second straight line may be a straight line obtained by symmetrically moving a straight line between an intersection A, where the straight line Le2 and the straight line Lc2 meet each other, and the center C around the windshield; the center C may be a point where a normal line Le1 from a center of the eyebox and a normal line Lc1 from the center of the image output unit meet each other; the straight lines Le2 and Le3 may be the upper and lower ones of the two straight lines Le2 and Le3, respectively, when a yz plane is viewed; and the straight lines Lc2 and Lc3 may be the right and left ones of the two straight lines Lc2 and Lc3, respectively, with respect to the image output part when the yz plane is viewed.

The image output unit and the plurality of optical elements may be arranged by being rotated them by 90 degrees around a straight line parallel to the y axis. The distance within a preset range may have a value of 0 or more.

The distance within a preset range may have a different value for at least some of the plurality of optical elements.

The first and second straight lines may have different inclinations.

The second straight line may be a straight line having the same inclination as the first straight line.

The plurality of optical elements may be spaced apart from each other with gaps therebetween.

The plurality of optical elements may be arranged such that the gaps are not visible when the plurality of optical elements are viewed from the image output unit.

The plurality of optical elements may each be formed in the shape of a bar extending in the lateral-axis direction of the image output unit.

The side sections of the plurality of optical elements may each be formed in a trapezoidal shape.

The plurality of optical elements may each be composed of a plurality of unit optical modules.

The plurality of optical elements may each be a reflective element.

The plurality of optical elements may each be a full mirror that reflects all incident light without transmitting it therethrough.

The plurality of optical elements may be disposed not to overlap each other with respect to the virtual image light generated from the image output unit.

The plurality of optical elements may each be a half mirror that transmits part of incident light therethrough and reflects part of incident light.

The plurality of optical elements may be disposed such that at least some of the plurality of optical elements overlap each other for the virtual image light generated from the image output unit.

The plurality of optical elements may each be composed of a combination of at least one of a reflective element, a refractive element, a diffractive element, and a holographic element.

The plurality of optical elements may be disposed inside an optical means.

The virtual image light output from the image output unit may be reflected by total internal reflection through the inner surface of the optical means and may then be transferred to the plurality of optical elements.

A correction lens having refractive power may be disposed on a surface of the optical means.

According to another aspect of the present invention, there is provided an optical system for a head-up display (HUD) system, the optical system including: an image output unit configured to output virtual image light; and a plurality of optical elements configured to transfer the virtual image light to a windshield; wherein the plurality of optical elements are each disposed at an inclination angle with respect to the image output unit and the windshield so that the virtual image light is transferred to an eyebox through the windshield; and wherein the plurality of optical elements are each disposed along a single straight line with centers thereof having a distance within a preset range from the single straight line.

When the lateral- and vertical-axis directions of the image output unit are called x_{d} and y_{d} axes, respectively, and a normal line from the center of a surface of the image output unit is called a z_{d} axis, the single straight line may be a straight line that is included in a y_{d}z_{d} plane defined by the y_{d} and z_{d} axes.

When the lateral- and vertical-axis directions of the eyebox are called an x axis and a y axis, respectively, and a normal direction from a center of a surface of the eyebox is called a z axis, and when straight lines corresponding to a field of view θe in a y-axis direction required by the eyebox are called Le2 and Le3, respectively, and straight lines corresponding to a maximum divergence angle θc in a y_{d}-axis direction of the image output unit are called Lc2 and Lc3, respectively: the single straight line may be a straight line obtained by symmetrically moving a straight line between an intersection point H where the straight lines Le2 and Lc3 meet each other and an intersection I where the straight lines Le3 and Lc2 meet each other around the windshield; the straight lines Le2 and Le3 may be the upper and lower ones of the two straight lines Le2 and Le3, respectively, when a yz plane is viewed; and the straight lines Lc2 and Lc3 may be the right and left ones of the two straight lines Lc2 and Lc3, respectively, with respect to the image output part when the yz plane is viewed.

The image output unit and the plurality of optical elements may be arranged by being rotated them by 90 degrees around a straight line parallel to the y axis.

The distance within a preset range may have a value of 0 or more.

The distance within a preset range may have a different value for at least some of the plurality of optical elements.

The plurality of optical elements may be arranged in close contact with each other without gaps therebetween.

The plurality of optical elements may each be formed in the shape of a bar extending in the lateral-axis direction of the image output unit.

The side sections of the plurality of optical elements may each be formed in a trapezoidal shape.

The plurality of optical elements may each be composed of a plurality of unit optical modules.

The plurality of optical elements may each be a reflective element.

The plurality of optical elements may each be a full mirror that reflects all incident light without transmitting it therethrough.

The plurality of optical elements may be disposed not to overlap each other with respect to the virtual image light generated from the image output unit.

The plurality of optical elements may each be a half mirror that transmits part of incident light therethrough and reflects part of incident light.

The plurality of optical elements may be disposed such that at least some of the plurality of optical elements overlap each other for the virtual image light generated from the image output unit.

The plurality of optical elements may each be composed of a combination of at least one of a reflective element, a refractive element, a diffractive element, and a holographic element.

The plurality of optical elements may be disposed inside an optical means.

The virtual image light output from the image output unit may be reflected by total internal reflection through an inner surface of the optical means and may then be transferred to the plurality of optical elements.

A correction lens having refractive power may be disposed on a surface of the optical means.

According to further another aspect of the present invention, there is provided an optical system for a head-up display (HUD) system, the optical system comprising: an image output unit configured to output virtual image light; a plurality of optical elements configured to transfer the virtual image light to a windshield; and the windshield configured to transfer the virtual image light, transferred from the plurality of optical elements, to an eyebox of a user; wherein the plurality of optical elements are each disposed at an inclination angle with respect to the image output unit and the windshield so that the virtual image light is transferred to the eyebox through the windshield.

The image output unit may comprises: a display unit configured to display a virtual image and output virtual image light corresponding to the displayed virtual image; and a light conversion unit configured to convert the incident virtual image light according to a preset condition and output the converted virtual image light.

The plurality of optical elements may be spaced apart from each other with gaps therebetween.

The plurality of optical elements may be arranged such that the gaps are not visible when the plurality of optical elements are viewed from the image output unit.

The plurality of optical elements may be each a full mirror that reflects all incident light without transmitting it therethrough; and the plurality of optical elements may be disposed not to overlap each other with respect to the virtual image light generated from the image output unit.

The plurality of optical elements may be each a half mirror that transmits part of incident light therethrough and reflects part of incident light; and the plurality of optical elements may be disposed such that at least some of the plurality of optical elements overlap each other for the virtual image light generated from the image output unit.

The plurality of optical elements may be disposed inside an optical means and a correction lens having refractive power may be disposed on a surface of the optical means.

### BRIEF DESCRIPTION OF THE DRAWINGS

The above and other objects, features, and advantages of the present invention will be more clearly understood from the following detailed description taken in conjunction with the accompanying drawings, in which:

FIGS. 1 to 3 show side, perspective and front views of an optical system for a HUD system according to an embodiment of the present invention, respectively;

FIGS. 4 to 6 are side views illustrating the principle by which a plurality of optical elements are arranged along first and second straight lines;

FIG. 7 shows optical paths of virtual image light between an image output unit and an eyebox in the optical system for a HUD system;

FIG. 8 shows a side view of an optical element having a trapezoidal sectional shape;

FIG. 9 shows an optical element composed of a plurality of unit optical modules;

FIGS. 10 to 12 show side, perspective and front views of an optical system for a HUD system according to another embodiment of the present invention, respectively;

FIG. 13 is a side view of an optical system for a HUD system according to still another embodiment of the present invention; and

FIGS. 14 to 16 are side views illustrating the principle by which a plurality of optical elements are arranged along a single straight line in the optical system for a HUD system of FIG. 13.

### DETAILED DESCRIPTION

Embodiments of the present invention will be described in detail below with reference to the accompanying drawings.

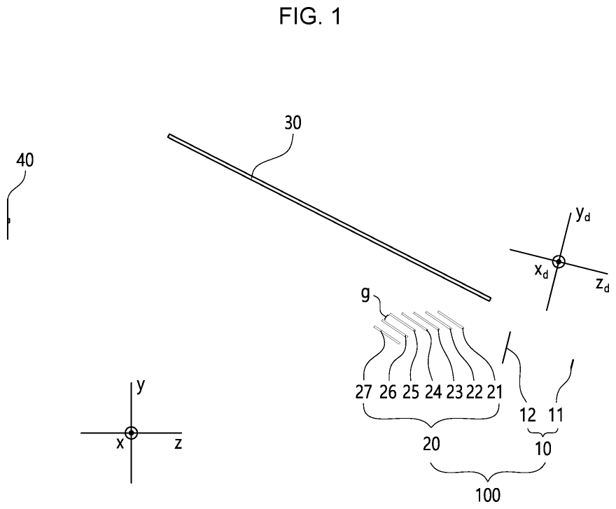

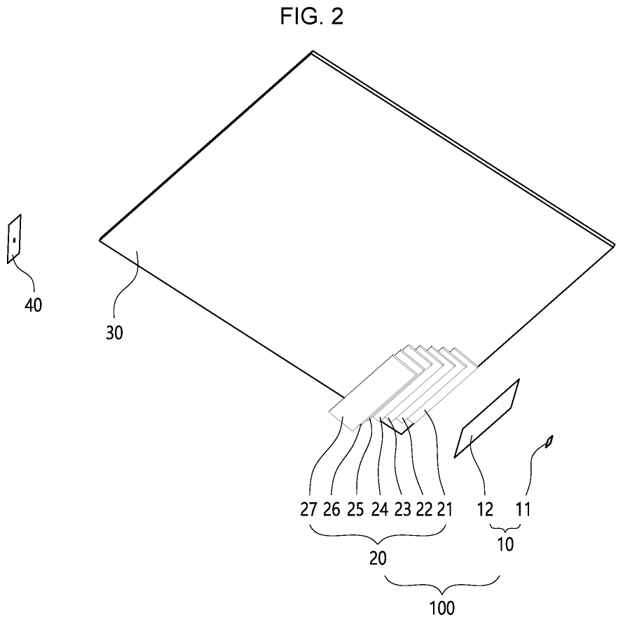

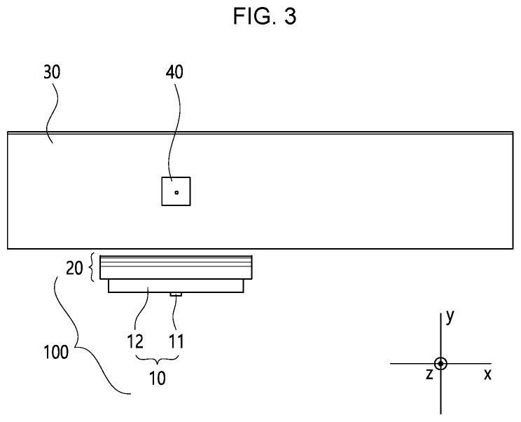

FIGS. 1 to 3 show side, perspective and front views of an optical system 100 for a HUD system according to an embodiment of the present invention, respectively.

Referring to FIGS. 1 to 3, the optical system 100 for an HUD system includes an image output unit 10 and a plurality of optical elements 21 to 27.

Furthermore, a HUD system includes the optical system 100 for an HUD system, and a windshield 30 acting as a combiner.

The image output unit 10 is a means for outputting virtual image light, which is image light corresponding to each virtual image. The virtual image may be text, a still image, or a moving image that is provided to the user.

In FIGS. 1 to 3, the lateral-axis direction of the eyebox 40 of a user is called an x axis, the vertical-axis direction of the eyebox 40 is called a y axis, and the normal direction from the center of the surface of the eyebox 40 is called a z axis.

Based on this coordinate system, the image output unit 10 is disposed lower than the windshield 30 when viewed from a side, as shown in FIG. 1. The reason for this is that, when the HUD system is applied to a vehicle, the image output unit 10 is disposed inside the dashboard of the vehicle.

The image output unit 10 may include a display unit 11 and an optical conversion unit 12.

The display unit 11 is a means for displaying a virtual image and outputting virtual image light corresponding to the displayed virtual image, and may be, e.g., a device such as a small-sized LCD, OLED, LCOS, or micro LED display, or the like.

The light conversion unit 12 is a means for converting incident virtual image light according to a preset condition, e.g., an optical path or a focal length, and outputting it, and may be, e.g., a collimator that converts incident light into parallel light and outputs it.

Alternatively, the light conversion unit 12 may be a lens, such as a convex lens or a concave lens, or a combination of a convex lens and a concave lens that converts incident light and outputs it to enlarge or reduce a virtual image according to a preset design requirement.

Furthermore, the light conversion unit 12 may be formed of a combination of at least one of a reflective element, a diffractive element, and a refractive element.

Although the display unit 11 and the light conversion unit 12 are spaced apart from each other by a distance in FIGS. 1 to 3, this is an example. It is obvious that they may have a different distance according to a design requirement or may be disposed close to each other in some cases.

The virtual image light output from the image output unit 10 is transferred to the plurality of optical elements 21 to 27.

The plurality of optical elements 21 to 27 serve to transfer virtual image light, output from the image output unit 10, to the windshield 30.

The virtual image light transferred to the windshield 30 is reflected from the windshield 30 and then transferred to the eyebox 40, thereby enabling the user to observe the virtual image.

Meanwhile, the windshield 30 acts as the combiner of the HUD system, and may be, e.g., the front or rear window of a vehicle or airplane.

The plurality of optical elements 21 to 27 are each disposed at an inclination angle with respect to the image output unit 10 and the windshield 30 so that the virtual image light output from the image output unit 10 is transferred to the eyebox 40 through the windshield 30.

The plurality of optical elements 21 to 27 are collectively referred to as an optical element group 20.

Although the plurality of optical elements 21 to 27 are shown as seven in number in FIGS. 1 to 3, this is an example. The number of the plurality of optical elements 21 to 27 is not limited to seven.

As an embodiment, at least some 21 to 24 of the plurality of optical elements 21 to 27 are arranged along a first straight line with the centers thereof having a distance within a preset range from the first straight line, and at least another some 25 to 27 of the plurality of optical elements 21 to 27 are arranged along a second straight line with the centers thereof having a distance within a preset range from the second straight line.

In FIGS. 1 to 3, when the lateral- and vertical-axis directions of the image output unit 10 are called x_{d} and y_{d} axes, respectively, and the normal line from the center of the surface of the image output unit 10 is called a z_{d} axis, the first and second straight lines are straight lines that are included in a y_{d}z_{d} plane defined by the y_{d} and z_{d} axes.

Furthermore, in FIGS. 1 to 3, the z_{d} axis, which is the normal line from the center of the surface of the image output unit 10, has an inclination angle with respect to the z axis.

Furthermore, the first and second straight lines may have different inclinations and have an intersection where they meet each other.

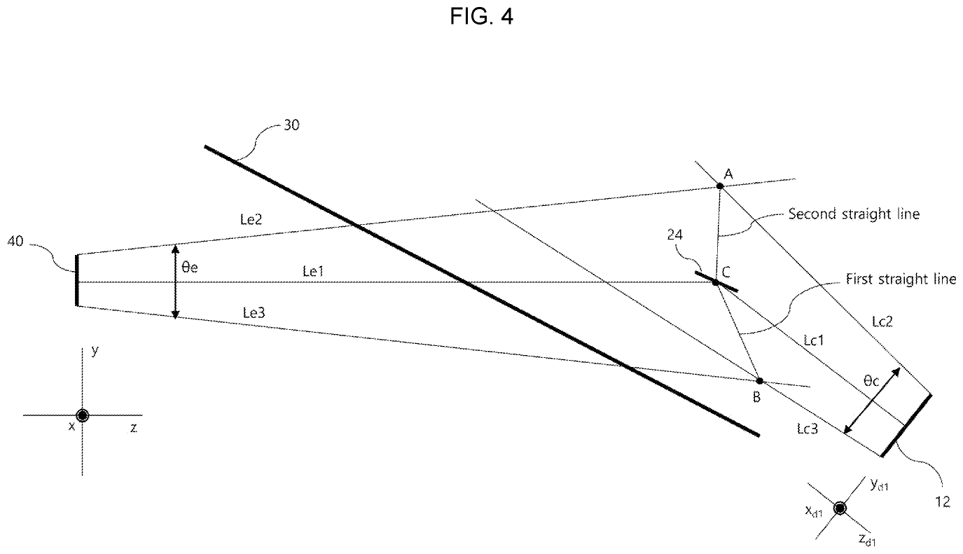

FIGS. 4 to 6 are side views illustrating the principle by which the plurality of optical elements 21 to 27 are arranged along the first and second straight lines.

In FIGS. 4 to 6, for convenience of description, the display unit 11 of the image output unit 10 is omitted, and only the light conversion unit 12 is shown. However, in practice, the display unit 11 is disposed in front of the light conversion unit 12, as shown in FIGS. 1 to 3. It should be noted that even when only the light conversion unit 12 is referred to below, it means the image output unit 10 including the display unit 11.

First, the eyebox 40 is positioned as shown in FIG. 4. As described above, the lateral-axis direction of the eyebox 40 corresponds to an x axis, the vertical-axis direction of the eyebox 40 corresponds to an y axis, a straight line parallel to the normal line from the center of the surface of the eyebox 40 corresponds to an z axis, and the x axis, the y axis and the z axis define an xyz coordinate system in which the x axis, the y axis, and the z axis are perpendicular to each other.

Furthermore, the image output unit 10 is disposed under the windshield 30.

Furthermore, in the image output unit 10, when the lateral- and vertical-axis directions of the image output unit 10 are called an x_{d1} axis and a y_{d1} axis, respectively, and the normal line from the center of the surface of the image output unit 10 is called a z_{d1} axis, the normal line from the center of the surface of the light conversion unit 12 is arranged to be included in a y_{d1}z_{d1} plane. In this case, the normal line is arranged inclined to the z_{d1} axis.

In the state where the eyebox 40 and the image output unit 10 are arranged as described above, one optical element 24 of the plurality of optical elements 21 to 27 is arranged at the center C where the normal line Le1 from the center of the eyebox 40 parallel to the z-axis and the normal line Lc1 from the center of the surface of the light conversion unit 12 meet each other.

As shown in FIG. 1, the optical element 24 is located at the center of the plurality of optical elements 21 to 27 composed of a total of seven optical elements when viewed from the side. The optical element 24 is arranged inclined to the eyebox 40 and the light conversion unit 12 so that the virtual image light from the center of the light conversion unit 12 passes through the center of the optical element 24 and is incident at the center of the eyebox 40.

Meanwhile, when two straight lines corresponding to the field of view θe in a vertical direction (a y-axis direction) required by the eyebox 40 are called Le2 and Le3, respectively, and two straight lines corresponding to a maximum divergence angle θc in the vertical-axis direction (a y_{d1}-axis direction) of the light conversion unit 12 are called Lc2 and Lc3, respectively, an intersection A where the straight lines Le2 and Lc2 meet each other and an intersection B where the straight lines Le3 and Lc3 meet each other may be determined.

In this case, the straight lines Le2 and Le3 are the upper and lower straight lines Le2 and Le3 of the two straight lines Le2 and Le3, respectively, when viewed from a side, i.e., when an yz plane is viewed, as shown in FIG. 4.

Furthermore, the straight lines Lc2 and Lc3 are the right and left straight lines Lc2 and Lc3 of the two straight lines Lc2 and Lc3, respectively, with respect to the image output unit 10 when viewed from the side, i.e., when the yz plane is viewed, as shown in FIG. 4.

In addition, the straight line between the intersection B and the center C is set as a first straight line, and the straight line between the intersection point A and the center C is set as a second straight line. In this case, the first and second straight lines have different inclinations and have an intersection at the center C.

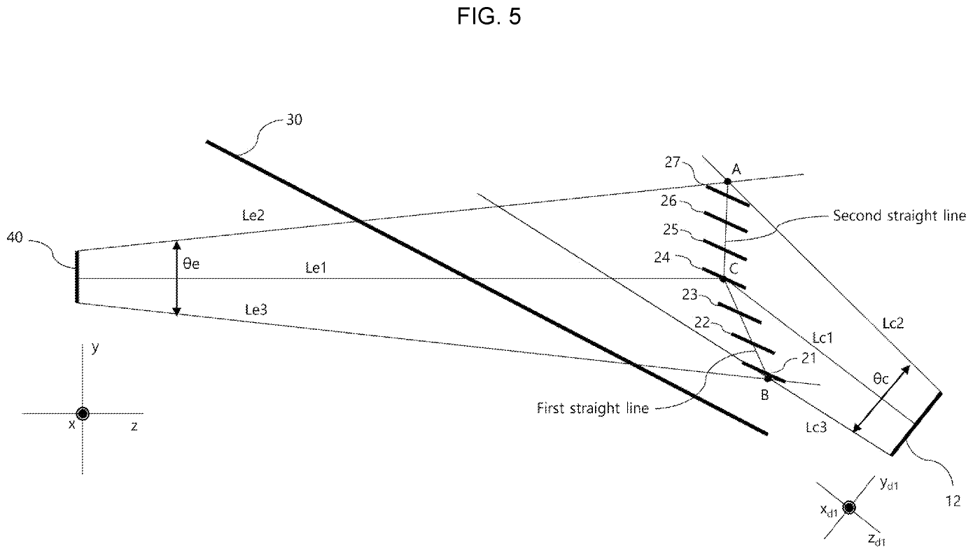

Next, as shown in FIG. 5, the plurality of optical elements 21 to 23 are spaced apart from each other with gaps g therebetween so that the centers thereof are positioned along the first straight line while having a distance within a preset range from the first straight line, and the plurality of optical elements 25 to 27 are spaced apart from each other with gaps g therebetween so that the centers thereof are positioned along the second straight line while having a distance within a preset range from the second straight line.

In this case, the inclination angles of the plurality of optical elements 21 to 23 and 25 to 27 may be the same as that of the optical elements 24, but do not necessarily have to be the same and may have a different inclination angle.

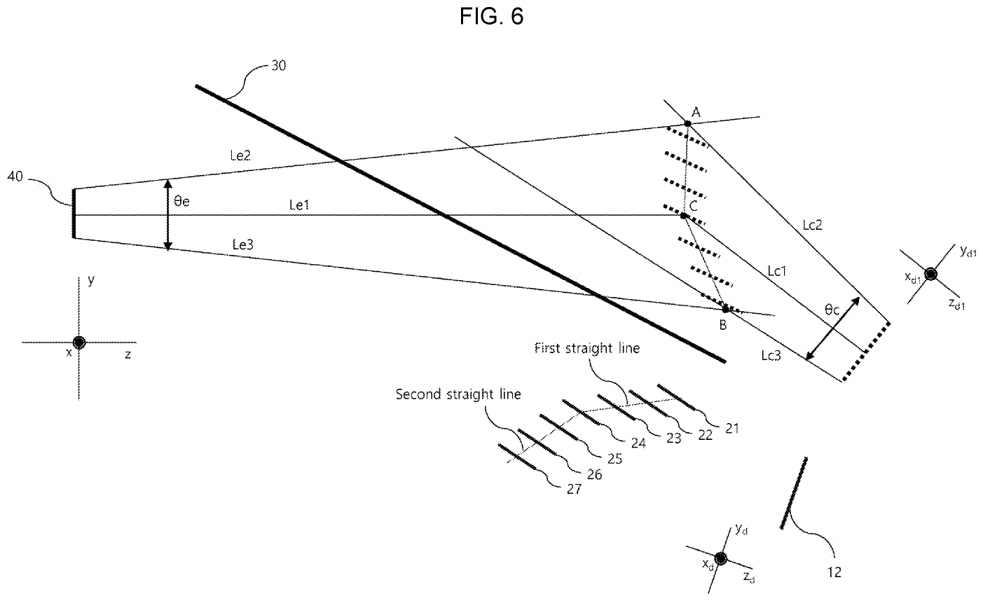

Next, when the image output unit 10 including the plurality of optical elements 21 to 27 and the light conversion unit 12 is symmetrically moved around the windshield 30 as shown in FIG. 6, the arrangement structure of the plurality of optical elements 21 to 27 shown in FIG. 1 may be obtained.

Meanwhile, as described above, each of the plurality of optical elements 21 to 27 is disposed along the first or second straight line while having a distance within a preset range from the first or second straight line. In this case, the distance within a preset range may have a value equal to or larger than 0.

In FIGS. 4 to 6, all of the plurality of optical elements 21 to 27 are arranged such that the centers thereof are located on the first or second straight line, which means that the distance within a preset range is zero.

Furthermore, the distance within a preset range may have the same value for all of the plurality of optical elements 21 to 27, but may have a different value for at least some of them.

For example, as shown in FIG. 1, when the side, i.e., the yz plane, is viewed, the distance within a preset range may be set to 0 for the central optical element 24. Additionally, for the optical elements 21 to 23 and 25 to 27 in the outward directions from the optical element 24, the distance from the first or second straight line may gradually increase as the distance from the optical element 24 increases. In this case, it can be seen that each of the center of the plurality of optical elements 21 to 27 are disposed along a gently curved line.

Meanwhile, although the first and second straight lines have been described as having different inclinations in FIGS. 1 to 6, the inclinations of the first and second straight lines may be the same depending on one or more conditions such as the field of view θe, the maximum divergence angle θc, and/or the location and/or inclination angle of the image output unit 10.

Furthermore, the second straight line may be a straight line that has the same inclination as the first straight line and appears like a straight line that is connected to the first straight line as a single line. In this case, the plurality of optical elements 21 to 27 are arranged such that the centers thereof are located along one single straight line while having a distance within a preset range from the one single straight line.

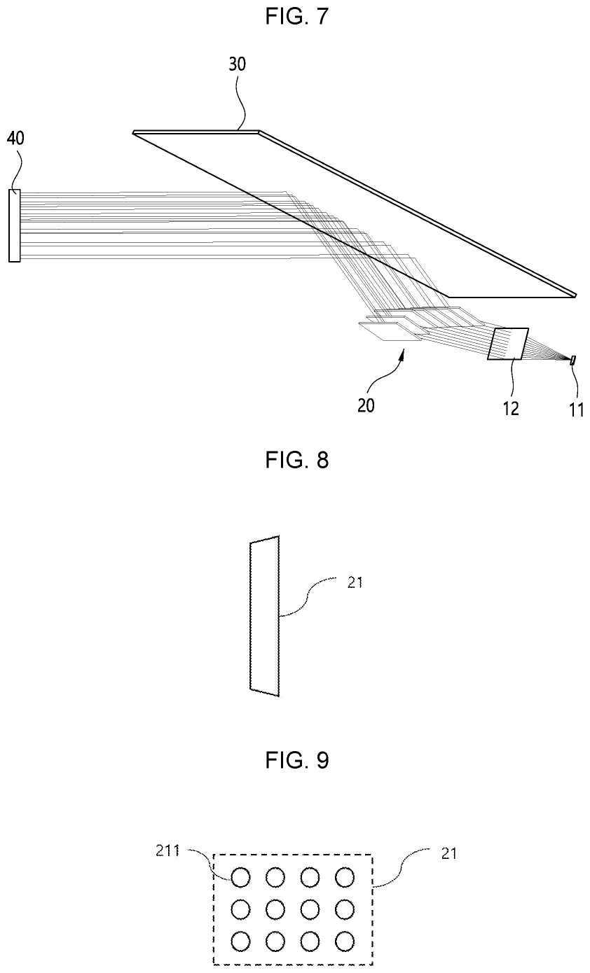

FIG. 7 shows optical paths of virtual image light between the image output unit 10 and the eyebox 40 in the optical system 100 for a HUD system shown in FIGS. 1 to 6.

As shown in this drawing, it can be seen that the virtual image light output from the center of the display unit 11 of the image output unit 10 is transferred to the plurality of optical elements 21 to 27 via the light conversion unit 12 and is then transferred to the windshield 30 through the gaps between the plurality of optical elements 21 to 27.

Each of the plurality of optical elements 21 to 27 transfers incident virtual image light to the windshield 30, and the virtual image light enters the eyebox 40 through the windshield 30.

Accordingly, it can be seen that a field of view and eyebox for the virtual image light output from one point of the display unit 11 are enlarged in the x-axis and y-axis directions. Thus, the arrangement structure of the plurality of optical elements 21 to 27 described above makes it possible to significantly reduce the volume of the optical system compared to that of the prior art.

The conventional optical system of a HUD system only reflects virtual image light, but cannot enlarge a field of Accordingly, in order to enlarge the view and an eyebox. field of view and the eyebox in the conventional HUD system, a bulky optical system is required. In contrast, the optical system 100 for a HUD system according to the present invention enlarges incident virtual image light using a plurality of optical elements 21 to 27, thereby obtaining an enlarged field of view and eyebox while reducing the volume of the optical system of the HUD system.

Meanwhile, in FIGS. 1 to 7, the plurality of optical elements 21 to 27 may be spaced apart from each other with the gaps g therebetween, as described above. The virtual image light output from the image output unit 10 may be transferred to the windshield 30 through the gaps g.

Furthermore, the plurality of optical elements 21 to 27 are preferably arranged such that the gaps g are not visible when the plurality of optical elements 21 to 27 are viewed from the image output unit 10.

In addition, when the location and inclination angle of the image output unit 10 and the directions in which the plurality of optical elements 21 to 27 are arranged are appropriately adjusted, the plurality of optical elements 21 to 27 may be arranged in close contact with each other without gaps therebetween.

Meanwhile, as shown in the drawing, each of the plurality of optical elements 21 to 27 preferably has a bar shape extending in the lateral-axis direction (the xd-axis direction) of the image output unit 10.

Furthermore, although each of the plurality of optical elements 21 to 27 is shown as having a rectangular surface in FIGS. 1 to 7, this is an example. It is obvious that each of the plurality of optical elements 21 to 27 may have a square shape, an elliptical shape, or other shapes.

Furthermore, the side section of each of the plurality of optical elements 21 to 27 may be formed in a trapezoidal shape.

FIG. 8 shows a side view of the optical element 21 having a trapezoidal sectional shape.

Since the plurality of optical elements 21 to 27 are disposed adjacent to each other, there may be cases where light to be incident on each of the plurality of optical elements 21 to 27 may be blocked by an adjacent optical element or may be re-reflected. In this case, light efficiency may decrease or a ghost image may occur. Accordingly, a user may feel uncomfortable when viewing a virtual image.

In order to overcome this problem, when the side section of the optical element 21 is formed in a trapezoidal shape having an inclination angle with respect to incident virtual image light, as shown in FIG. 8, there may be advantages in that the occurrence of a ghost image can be reduced when the virtual image light output from the image output unit 10 is transferred to the windshield 30 and in that the optical efficiency of the virtual image light can be improved.

Meanwhile, each of the plurality of optical elements 21 to 27 may be composed of a plurality of unit optical modules.

FIG. 9 shows an optical element 21 composed of a plurality of unit optical modules 211.

As shown in FIG. 9, for example, the one optical element 21 may be formed by arranging a plurality of small-sized unit optical modules 211 at intervals in a two-dimensional array form.

In FIG. 9, the unit optical modules 211 are arranged at intervals, but they may be arranged at considerably narrow intervals or be arranged without intervals.

Meanwhile, the plurality of optical elements 21 to 27 may each be a reflective element that reflects incident light.

In this case, the plurality of optical elements 21 to 27 may each be a full mirror that reflects incident light without transmitting it therethrough. For example, the plurality of optical elements 21 to 27 may be made of a metal material having a reflectance of 100% or a high reflectance close to 100%.

In this case, it is preferable that the plurality of optical elements 21 to 27 be disposed not to overlap each other with respect to the virtual image light generated from the image output unit 10. The reason for this is that an adjacent optical element 21, 22, 23, . . . , or 27 may block virtual image light to be incident on another optical element 21, 22, 23, . . . , or 27.

Furthermore, the plurality of optical elements 21 to 27 may each be a half mirror that partially transmits incident light therethrough and partially reflects incident light.

In this case, the plurality of optical elements 21 to 27 may be arranged such that at least some of the plurality of optical elements 21 to 27 overlap each other with respect to the virtual image light output from the image output unit 10. In the case of half mirrors, even when the plurality of optical elements 21 to 27 overlap each other, part of the virtual image light can pass through them, so that the virtual image light can be transferred to the eyebox 40 without omission.

Furthermore, at least one of the reflectance and transmittance of some of the plurality of optical elements 21 to 27 may be different from that of the rest. In other words, the reflectance and/or the transmittance may not be the same for the plurality of optical elements 21 to 27.

As described above, the virtual image light entering each optical element 21, 22, 23, . . . , or 27 may be partially blocked by an adjacent optical element 21, 22, 23, . . . , or 27. Accordingly, the light quantity distributions of the virtual image light entering the respective optical elements 21 to 27 may not be uniform for the surfaces of the optical elements 21 to 27 (the surfaces on which the virtual image light is incident).

In order to compensate for the non-uniform light quantity distributions, it is preferable to make at least one of reflectance and transmittance different for some of the plurality of optical elements 21 to 27.

For example, the light quantity distributions of virtual image light incident on the respective surfaces of the optical elements 21 to 27 are calculated, a plurality of regions are appropriately selected based on the calculated light quantity distributions, and then the respective regions may be coated with reflective materials having different types of reflectance.

In this case, coating may be performed on a region having a smaller quantity of light so that the region has a higher reflectance. In contrast, coating may be performed on a region having a larger quantity of light so that the region has a lower reflectance.

According to this configuration, there may be an advantage in that the uniformity of the virtual image light entering the eyebox 40 can be increased.

Meanwhile, in the embodiment of FIGS. 1 to 7, the plurality of optical elements 21 to 27 have gaps therebetween and the gaps are considerably narrow, so that it is preferable that the plurality of optical elements 21 to 27 each be a half mirror.

Furthermore, it is obvious that the plurality of optical elements 21 to 27 may each be composed of a combination of at least one of a reflective element, a refractive element, a diffractive element, and a holographic element.

Meanwhile, although the gaps g between the plurality of optical elements 21 to 27 are preferably the same, they are not necessarily all the same. It is obvious that the gap between at least some of the plurality of optical elements 21 to 27 may be different.

Furthermore, the plurality of optical elements 21 to 27 may be arranged in close contact with each other without gaps therebetween.

Meanwhile, the plurality of optical elements 21 to 27 may be embedded and disposed inside an optical means (not shown) such as a lens formed of a synthetic resin material. This optical means serves as a waveguide through which virtual image light propagates.

In this case, the virtual image light output from the image output unit 10 may be reflected by total internal reflection on the inner surface of the optical means and transferred to the plurality of optical elements 21 to 27. This configuration has the advantage of further reducing the overall volume of the image output unit 10 and the plurality of optical elements 21 to 27.

Furthermore, when the plurality of optical elements 21 to 27 are embedded and disposed inside the optical means, a correction lens (not shown) having refractive power may be disposed on the surface of an optical means through which virtual image light is output from the plurality of optical elements 21 to 27. According to this correction lens, there may be an advantage in that a clearer virtual image can be provided by appropriately compensating for an error due to the curvature of the windshield 30 through the refractive power of the correction lens.

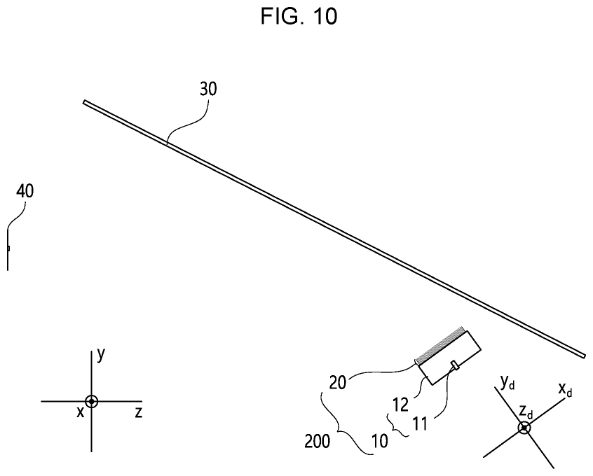

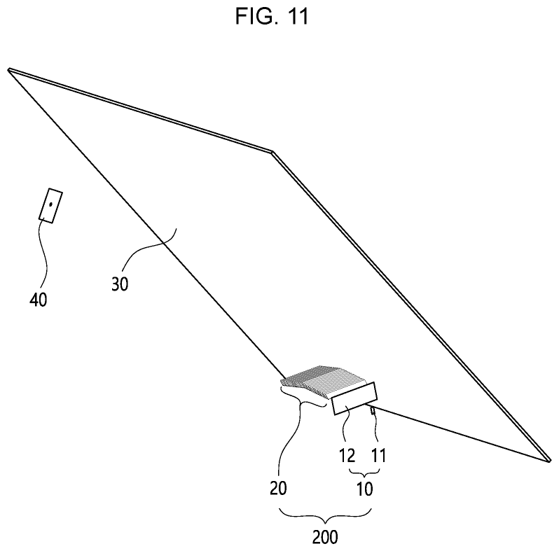

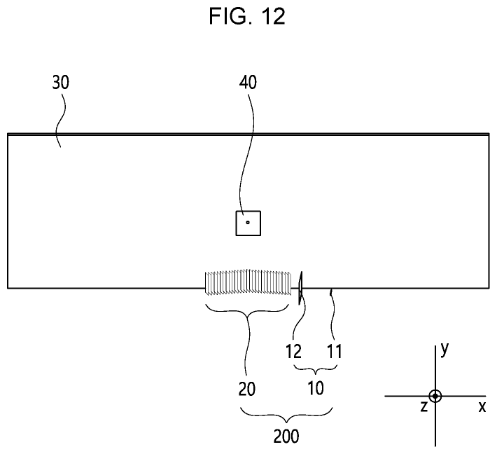

FIGS. 10 to 12 show side, perspective and front views of an optical system 200 for a HUD system according to another embodiment of the present invention, respectively.

The optical system 200 for a HUD system according to the embodiment of FIGS. 10 to 12 is basically the same as the optical system 100 for a HUD system described with reference to FIGS. 1 to 7, except that an image output unit 10 is located on one side of a lower region below the forward direction from an eyebox 40.

The optical system 200 corresponds to the configuration obtained by rotating the image output unit 10 and plurality of optical elements 21 to 27 of the optical system 100 for a HUD system, described with reference to FIGS. 1 to 7, by 90 degrees around a straight line parallel to the y axis.

Accordingly, the first and second straight lines in the optical system 200 for a HUD system may be viewed as being obtained by rotating the first and second straight lines of the optical system 100 for a HUD system by 90 degrees around the straight line parallel to the y axis.

In this case, the straight line serving as the central axis of the rotation movement may be a straight line passing through any one of the plurality of optical elements 21 to 27, e.g., the optical element 24 located at the center of the plurality of optical elements 21 to 27.

As described above, in the embodiments of FIGS. 10 to 12, at least some 21 to 24 of the plurality of optical elements 21 to 27 are arranged along a first straight line with the centers thereof having a distance within a preset range from the first straight line, and at least another some 25 to 27 of the plurality of optical elements 21 to 27 are disposed along a second straight line with the centers thereof having a distance within a preset range from the second straight line.

Also, in this case, the second straight line may have an inclination different from that of the first straight line, and may have an intersection where they meet each other. Furthermore, the second straight line may be a straight line that has the same inclination as the first straight line and appears like a straight line connected to the first straight line as a single line.

Furthermore, also, in this case, when the lateral- and vertical-axis directions of the image output unit 10 are called x_{d} and y_{d} axes, respectively, and the normal line from the center of the surface of the image output unit 10 is called a z_{d} axis, the first and second straight lines are straight lines that are included in a y_{d}z_{d} plane defined by the y_{d} and z_{d} axes.

Since other configurations are the same as those of the optical system 100 for a HUD system described with reference to FIGS. 1 to 7, detailed descriptions thereof are omitted.

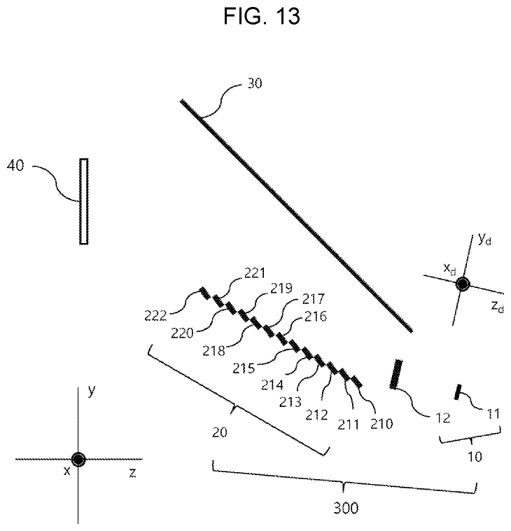

FIG. 13 is a side view of an optical system 300 for a HUD system according to still another embodiment of the present invention.

The optical system 300 for a HUD system of FIG. 13 is similar to the optical system 100 for a HUD system described with reference to FIGS. 1 to 7, except that the centers of a plurality of optical elements 210 to 222 are arranged along a single straight line while having a distance within a preset range from the single straight line.

Also, in this case, as described above, when the lateral- and vertical-axis directions of an image output unit 10 are called an x_{d} axis and a y_{d} axis, respectively, and the normal line from the center of the surface of the image output unit 10 is called a z_{d} axis, the image output unit 10 is arranged such that the normal line from the center of the surface of the image output unit 10 (i.e., a light conversion unit 12) is included in a y_{d}z_{d} plane.

Furthermore, the normal line is arranged inclined to the z_{d} axis.

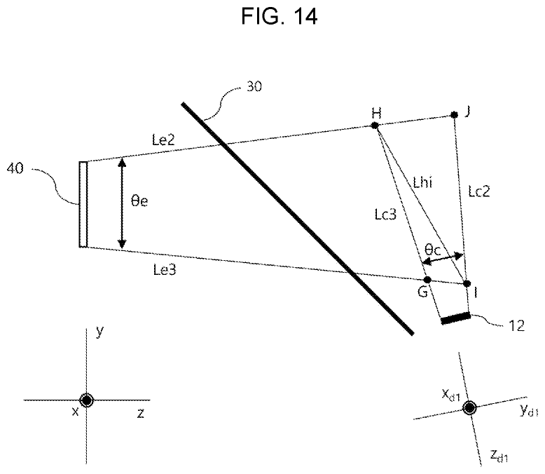

FIGS. 14 to 16 are side views illustrating the principle by which the plurality of optical elements 210 to 222 are disposed along a single straight line in the optical system 300 for a HUD system.

First, as shown in FIG. 14, an eyebox 40 and an image output unit 10 are arranged. This is the same as described with reference to FIG. 4.

In a state in which the eyebox 40 and the image output unit 10 are arranged as described above, there are obtained four intersections G, H, I, and J where two straight lines Le2 and Le3 corresponding to a field of view θe in the vertical direction (a y-axis direction) required by the eyebox 40 and two straight lines Lc2 and Lc3 corresponding to a maximum divergence angle θc in the vertical-axis direction (a y_{d1}-axis direction) of the light conversion unit 12 (the image output unit 10) meet each other.

As shown in FIG. 14, when viewed from a side, i.e., when a yz plane is viewed, one single straight line Lhi is set between the intersection H where the upper one Le2 of the two straight lines Le2 and Le3 and the left one Lc3 of the two straight lines Lc2 and Lc3 meet each other and the intersection point I where the lower one Le3 of the two straight lines Le2 and Le3 and the right one Lc2 of the two straight lines Lc2 and Lc3 meet each other, among the intersections G, H, I, and J.

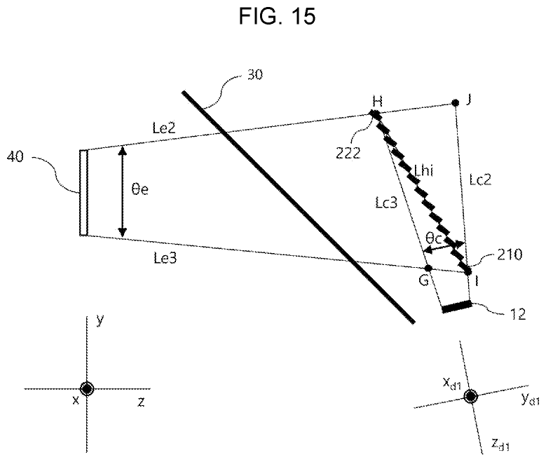

Next, as shown in FIG. 15, the plurality of optical elements 210 to 222 are disposed such that the centers thereof are positioned along the straight line Lhi.

In FIG. 15, only the first and last ones 210 and 222 of the plurality of optical elements 210 to 222 are denoted by reference numerals.

Also, in this case, the inclination angles of the plurality of optical elements 210 to 222 may all be the same, but do not necessarily have to be the same. At least some of the plurality of optical elements 210 to 22 may have a different inclination angle.

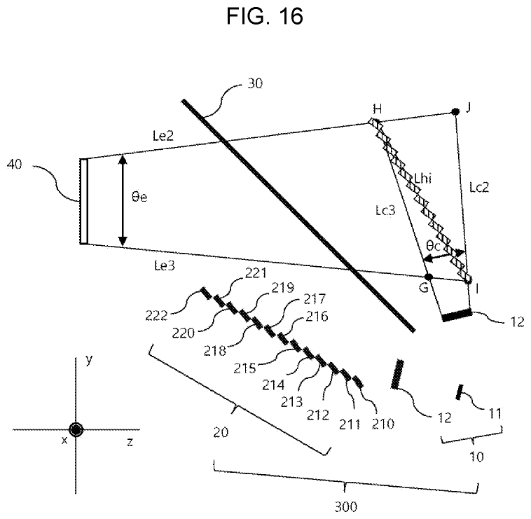

Further, when the plurality of optical elements 210 to 222 and the image output unit 10 including the light conversion unit 12 are symmetrically moved around the windshield 30, as shown in FIG. 16, the arrangement structure of the plurality of optical elements 210 to 222 such as that shown in FIG. 13 is obtained.

In the optical system 300 for a HUD system of FIGS. 13 to 16, the plurality of optical elements 210 to 222 are arranged in close contact with each other, as shown in the drawings, so that there are no gaps therebetween, but this is an example. It is obvious that the plurality of optical elements 210 to 222 may be arranged spaced apart such that there are gaps therebetween.

Furthermore, in the optical system 300 for a HUD system of FIGS. 13 to 16, the plurality of optical elements 210 to 222 may each be a half mirror that partially transmit incident light therethrough and partially reflects incident light. It is preferable that the plurality of optical elements 210 to 222 may each be a full mirror that reflects all incident light without transmitting it.

Meanwhile, although not shown, an optical system for a HUD system similar to the optical system 200 for a HUD system of FIGS. 10 to 12 may be obtained when the image output unit 10 and plurality of optical elements 210 to 222 of the optical system 300 for a HUD system are rotated by 90 degrees around a straight line parallel to the y axis, as described with reference to FIGS. 10 to 12.

Since other configurations are the same as those described in the optical systems 100 and 200 for a HUD system of the above-described embodiments, detailed descriptions thereof are omitted.

According to the present invention, the eyebox and the field of view may be enlarged without increasing the volume of the optical system by the arrangement structure of the plurality of optical elements 21 to 27 and 210 to 222. Accordingly, compared to the conventional HUD systems, the present invention may significantly reduce the volume of the optical system.

According to the tests of the applicant based on a field of view of 45 degrees, the optical systems 100, 200, and 300 for a HUD system according to the present invention had the effect of reducing the volume by about 5 times that of the prior art while providing the same eyebox and field of view. It will be apparent to a person skilled in the art that the volume may be reduced at a different rate at a different field of view.

According to the present invention, there may be provided the optical system for a HUD system capable of significantly reducing the volume thereof while enlarging an eyebox and a field of view.

Although the present invention has been described above with reference to the embodiments of the present invention, this is an example. A person having ordinary skill in the art to which the present invention pertains may make other various modifications and alterations within the scope of the present invention determined by the attached claims and the accompanying drawings. It should be noted that these modifications and alterations are all included in the scope of equivalent rights of the present invention.

What is claimed is:

1. An optical system for a head-up display (HUD) system, the optical system comprising:
an image output unit configured to output virtual image light; and
a plurality of optical elements configured to transfer the virtual image light to a windshield;
wherein the plurality of optical elements are each disposed at an inclination angle with respect to the image output unit and the windshield so that the virtual image light is transferred to an eyebox through the windshield; and
at least some of the plurality of optical elements are arranged along a first straight line with centers thereof having a distance within a preset range from the first straight line, and at least another some of the plurality of optical elements are disposed along a second straight line with centers thereof having a distance within a preset range from the second straight line.

2. The optical system of claim 1, wherein, when lateral- and vertical-axis directions of the image output unit are called x_{d} and y_{d} axes, respectively, and a normal line from a center of a surface of the image output unit is called a z_{d} axis, the first and second straight lines are straight lines that are included in a y_{d}z_{d} plane defined by the y_{d} and z_{d} axes.

3. The optical system of claim 2, wherein:
when lateral and vertical directions of the eyebox are called an x axis and a y axis, respectively, and a normal direction from a center of a surface of the eyebox is called a z axis; and
when straight lines corresponding to a field of view θe in a y-axis direction required by the eyebox are called Le2 and Le3, respectively, and straight lines corresponding to a maximum divergence angle θc in a y_{d}-axis direction of the image output unit are called Lc2 and Lc3, respectively:
the first straight line is a straight line obtained by symmetrically moving a straight line between an intersection point B, where the straight lines Le3 and Lc3 meet each other, and a center C around the windshield;
the second straight line is a straight line obtained by symmetrically moving a straight line between an intersection A, where the straight line Le2 and the straight line Lc2 meet each other, and the center C around the windshield;
the center C is a point where a normal line Le1 from a center of the eyebox and a normal line Lc1 from a center of the image output unit meet each other;
the straight lines Le2 and Le3 are upper and lower ones of the two straight lines Le2 and Le3, respectively, when a yz plane is viewed; and
the straight lines Lc2 and Lc3 are right and left ones of the two straight lines Lc2 and Lc3, respectively, with respect to the image output unit when the yz plane is viewed.

4. The optical system of claim 3, wherein the image output unit and the plurality of optical elements are arranged by being rotated by 90 degrees around a straight line parallel to the y axis.

5. The optical system of claim 1, wherein the distance within a preset range has a value of 0 or more.

6. The optical system of claim 1, wherein the distance within a preset range has a different value for at least some of the plurality of optical elements.

7. The optical system of claim 1, wherein the first and second straight lines have different inclinations.

8. The optical system of claim 1, wherein the second straight line is a straight line having a same inclination as the first straight line.

9. The optical system of claim 1, wherein the plurality of optical elements are spaced apart from each other with gaps therebetween.

10. The optical system of claim 9, wherein the plurality of optical elements are arranged such that the gaps are not visible when the plurality of optical elements are viewed from the image output unit.

11. The optical system of claim 1, wherein the plurality of optical elements are each formed in a shape of a bar extending in the lateral-axis direction of the image output unit.

12. The optical system of claim 1, wherein side sections of the plurality of optical elements are each formed in a trapezoidal shape.

13. The optical system of claim 1, wherein the plurality of optical elements are each composed of a plurality of unit optical modules.

14. The optical system of claim 1, wherein the plurality of optical elements are each a reflective element.

15. The optical system of claim 14, wherein the plurality of optical elements are each a full mirror that reflects all incident light without transmitting it therethrough.

16. The optical system of claim 15, wherein the plurality of optical elements are disposed not to overlap each other with respect to the virtual image light generated from the image output unit.

17. The optical system of claim 14, wherein the plurality of optical elements are each a half mirror that transmits part of incident light therethrough and reflects part of incident light.

18. The optical system of claim 17, wherein the plurality of optical elements are disposed such that at least some of the plurality of optical elements overlap each other for the virtual image light generated from the image output unit.

19. The optical system of claim 1, wherein the plurality of optical elements are each composed of a combination of at least one of a reflective element, a refractive element, a diffractive element, and a holographic element.

20. The optical system of claim 1, wherein the plurality of optical elements are disposed inside an optical means.

21. The optical system of claim 20, wherein the virtual image light output from the image output unit is reflected by total internal reflection through an inner surface of the optical means and is then transferred to the plurality of optical elements.

22. The optical system of claim 20, wherein a correction lens having refractive power is disposed on a surface of the optical means.

23. An optical system for a head-up display (HUD) system, the optical system comprising:
an image output unit configured to output virtual image light; and
a plurality of optical elements configured to transfer the virtual image light to a windshield;
wherein the plurality of optical elements are each disposed at an inclination angle with respect to the image output unit and the windshield so that the virtual image light is transferred to an eyebox through the windshield; and
wherein the plurality of optical elements are each disposed along a single straight line with centers thereof having a distance within a preset range from the single straight line.

24. The optical system of claim 23, wherein, when lateral- and vertical-axis directions of the image output unit are called x_{d} and y_{d} axes, respectively, and a normal line from a center of a surface of the image output unit is called a z_{d} axis, the single straight line is a straight line that is included in a y_{d}z_{d} plane defined by the y_{d} and z_{d} axes.

25. The optical system of claim 24, wherein:
when lateral- and vertical-axis directions of the eyebox are called an x axis and a y axis, respectively, and a normal direction from a center of a surface of the eyebox is called a z axis; and
when straight lines corresponding to a field of view θe in a y-axis direction required by the eyebox are called Le2 and Le3, respectively, and straight lines corresponding to a maximum divergence angle θc in a y_{d}-axis direction of the image output unit are called Lc2 and Lc3, respectively:
the single straight line is a straight line obtained by symmetrically moving a straight line between an intersection point H where the straight lines Le2 and Lc3 meet each other and an intersection I where the straight lines Le3 and Lc2 meet each other around the windshield;
the straight lines Le2 and Le3 are upper and lower ones of the two straight lines Le2 and Le3, respectively, when a yz plane is viewed; and
the straight lines Lc2 and Lc3 are right and left ones of the two straight lines Lc2 and Lc3, respectively, with respect to the image output unit when the yz plane is viewed.

26. The optical system of claim 25, wherein the image output unit and the plurality of optical elements are arranged by being rotated by 90 degrees around a straight line parallel to the y axis.

27. The optical system of claim 23, wherein the distance within a preset range has a value of 0 or more.

28. The optical system of claim 23, wherein the distance within a preset range has a different value for at least some of the plurality of optical elements.

29. The optical system of claim 23, wherein the plurality of optical elements are arranged in close contact with each other without gaps therebetween.

30. The optical system of claim 23, wherein the plurality of optical elements are each formed in a shape of a bar extending in a lateral-axis direction of the image output unit.

31. The optical system of claim 23, wherein side sections of the plurality of optical elements are each formed in a trapezoidal shape.

32. The optical system of claim 23, wherein the plurality of optical elements are each composed of a plurality of unit optical modules.

33. The optical system of claim 23, wherein the plurality of optical elements are each a reflective element.

34. The optical system of claim 33, wherein the plurality of optical elements are each a full mirror that reflects all incident light without transmitting it therethrough.

35. The optical system of claim 34, wherein the plurality of optical elements are disposed not to overlap each other with respect to the virtual image light generated from the image output unit.

36. The optical system of claim 33, wherein the plurality of optical elements are each a half mirror that transmits part of incident light therethrough and reflects part of incident light.

37. The optical system of claim 36, wherein the plurality of optical elements are disposed such that at least some of the plurality of optical elements overlap each other for the virtual image light generated from the image output unit.

38. The optical system of claim 23, wherein the plurality of optical elements are each composed of a combination of at least one of a reflective element, a refractive element, a diffractive element, and a holographic element.

39. The optical system of claim 23, wherein the plurality of optical elements are disposed inside an optical means.

40. The optical system of claim 39, wherein the virtual image light output from the image output unit is reflected by total internal reflection through an inner surface of the optical means and is then transferred to the plurality of optical elements.

41. The optical system of claim 39, wherein a correction lens having refractive power is disposed on a surface of the optical means.

42. An optical system for a head-up display (HUD) system, the optical system comprising:
an image output unit configured to output virtual image light;
a plurality of optical elements configured to transfer the virtual image light to a windshield; and
the windshield configured to transfer the virtual image light, transferred from the plurality of optical elements, to an eyebox of a user;
wherein the plurality of optical elements are each disposed at an inclination angle with respect to the image output unit and the windshield so that the virtual image light is transferred to the eyebox through the windshield.

43. The optical system of claim 42, wherein the image output unit comprises :
a display unit configured to display a virtual image and output virtual image light corresponding to the displayed virtual image; and
a light conversion unit configured to convert the incident virtual image light according to a preset condition and output the converted virtual image light.

44. The optical system of claim 42, wherein the plurality of optical elements are spaced apart from each other with gaps therebetween.

45. The optical system of claim 44, wherein the plurality of optical elements are arranged such that the gaps are not visible when the plurality of optical elements are viewed from the image output unit.

46. The optical system of claim 42, wherein:
the plurality of optical elements are each a full mirror that reflects all incident light without transmitting it therethrough; and
the plurality of optical elements are disposed not to overlap each other with respect to the virtual image light generated from the image output unit.

47. The optical system of claim 42, wherein:
the plurality of optical elements are each a half mirror that transmits part of incident light therethrough and reflects part of incident light; and
the plurality of optical elements are disposed such that at least some of the plurality of optical elements overlap each other for the virtual image light generated from the image output unit.

48. The optical system of claim 42, wherein the plurality of optical elements are disposed inside an optical means and a correction lens having refractive power is disposed on a surface of the optical means.
